(19) United States
(12) Patent Application Publication
(10) Pub. No.: US 2013/0251934 A1
(43) Pub. Date: Sep. 26, 2013

(54) ORNAMENTED SUBSTRATE AND METHODS FOR FORMING THE SAME

(71) Applicants: Maria Veronica Caracciolo, Mississauga (CA); Edin Devedzic, Milton (CA)

(72) Inventors: Maria Veronica Caracciolo, Mississauga (CA); Edin Devedzic, Milton (CA)

(21) Appl. No.: 13/428,197

(22) Filed: Mar. 23, 2012

(51) Int. Cl. B44C 3/12; B32B 3/08

(52) U.S. Cl. CPC B44C 3/12; B32B 3/08
USPC 428/67; 156/293

(57) ABSTRACT

A method for inlaying an ornament comprising one or more gems into a substrate comprising forming a cavity within a portion of a surface of the substrate and securing an ornament in the cavity. In particular, a method for inlaying an ornament having one or more gems into a substrate is shown. The method includes forming a cavity within a portion of a surface of the substrate and securing an ornament in the cavity. An ornamented substrate is also shown. The substrate includes a cavity extending along a surface of the substrate and an ornament having one or more gems, and the cavity is sized to receive the ornament and the ornament is secured in the cavity.

### FIELD

This invention relates to a product and method for inlaying an ornament into a substrate, such as, for example, but not limited to, floorboards, trim and crown moldings in a home, office or commercial establishment.

### INTRODUCTION

Celebrities and wealthy individuals have popularized the inlaying of precious gemstones such as crystals, diamonds and rubies into common articles such as handbags, watches and even cellular phones. Manufacturers now offer less expensive products ornamented with replica gems (such as cubic zirconia) which emulate the more expensive products with authentic precious gems. However, there exists a need for a product and method for ornamenting substrates, such as, for example, but not limited to, floorboards, trim and crown moldings in a home, office or commercial establishment.

### SUMMARY

This invention relates to a product and method for inlaying an ornament into a substrate, such as, for example, but not limited to, floorboards, trim and crown moldings in a home, office or commercial establishment.

In particular, a method for inlaying an ornament having one or more gems into a substrate is shown. The method includes forming a cavity within a portion of a surface of the substrate and securing an ornament in the cavity.

The method further includes after securing the ornament in the cavity, sealing the cavity with a substantially transparent cover.

Further, the ornament can be secured in the cavity so that no portion thereof protrudes beyond the portion of the surface of the substrate.

Moreover, after sealing the cavity with the substantially transparent cover, the cover can be flush with the surface of the substrate.

Further, sealing the cavity with the substantially transparent cover includes laying the cover in the cavity above the ornament and forcing the cover towards the ornament until the opposing face of the cover is flush with the surface of the substrate. Further, a sealant can be applied between the cover and the surface of the substrate.

The ornament can be secured inside the cavity by, for example, but not limited to, friction fitting the ornament inside the recess or bonding the ornament in the cavity with an adhesive.

The ornament can be formed by bonding the one or more gems to a second substrate prior to securing the ornament in the cavity.

Further, an interior surface of the cavity can be colored prior to securing the ornament inside the cavity.

The second substrate can be selected from the group consisting of mesh and fabric.

The substrate can be, for example, but not limited to, a floorboard or crown molding.

In addition, lighting can be inserted in the cavity.

Applicants' teachings also include an ornamented substrate where the substrate includes a cavity extending along a surface of the substrate and an ornament having one or more gems, and the cavity is sized to receive the ornament and the ornament is secured in the cavity.

In particular, the ornamented substrate has a substantially transparent cover in the cavity overlaying the ornament. The substantially transparent cover can be flush with the surface of the substrate.

Moreover, a sealant can be provided between the cover and the surface of the substrate.

Further, the ornament can be friction fitted inside the cavity.

Moreover, a second substrate can be provided between the one or more gems and the cavity of the substrate. The second substrate can be selected from the group consisting of mesh and fabric.

Further, the ornamented substrate can have lighting received in the cavity.

### DRAWINGS

Embodiments of the invention may be understood by reference to the following detailed description when read with the accompanied drawings in which:

FIG. 1a is a partially exploded view of an ornamented wooden substrate, in accordance with some embodiments of the invention;

FIG. 1b is an ornamented substrate, in accordance with some embodiments of the invention;

FIG. 1c is an ornamented substrate, in accordance with some embodiments of the invention and

FIG. 2 is a method for inlaying an ornament into a wooden substrate, in accordance with some embodiments of the invention.

### DESCRIPTION OF VARIOUS EMBODIMENTS

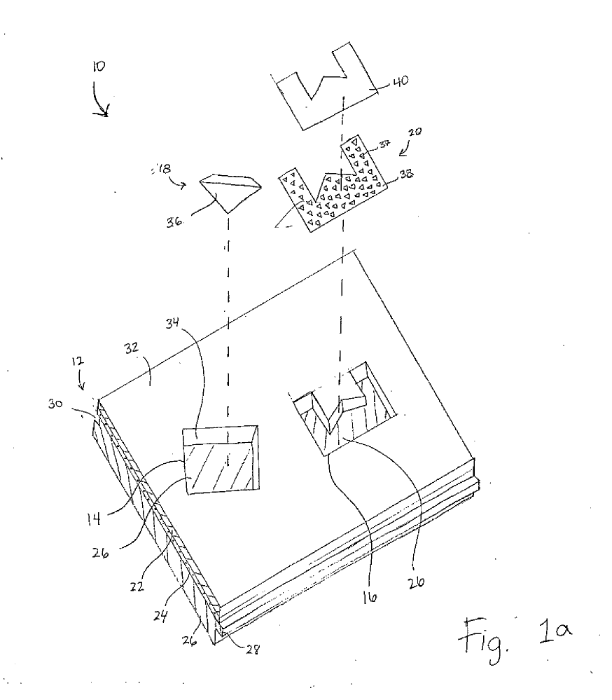

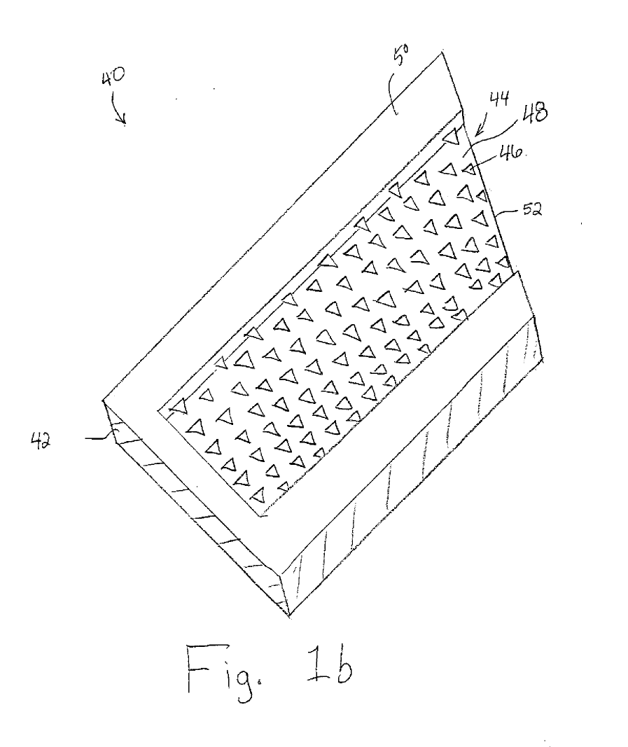

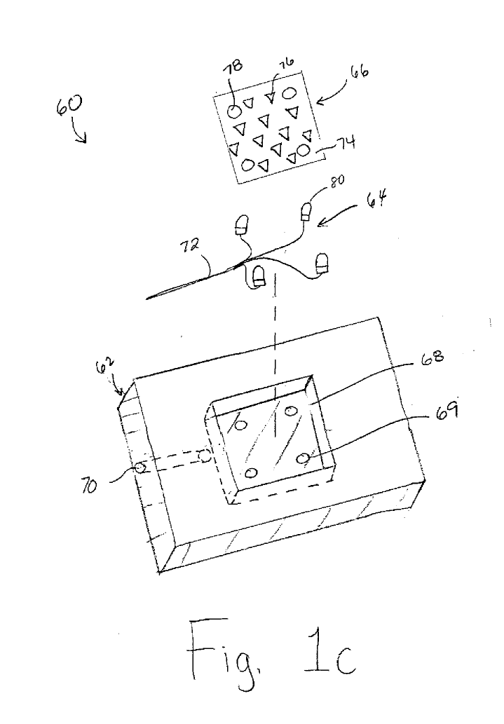

FIG. 1 is a partially exploded view of an ornamented substrate 10 in accordance with some embodiments of the invention. In the example shown, ornamented substrate 10 is an ornamented floorboard. As shown, substrate 10 includes wooden substrate 12, cavities 14, 16 and ornaments 18, 20.

As used herein and in the claims, the term substrate refers to both substrates made of wood, for example, hardwood, as well as substrates made from processed or simulated wood. For example, as used herein, a “wooden” substrate may refer to substrates made of solid wood (e.g., oak or pine), plywood, particle board, laminates (e.g., a combination of a melamine resin, a photographic applique and a clear protective layer), or synthetic fiber boards.

In the example shown, wooden substrate 12 is a laminate floorboard comprising a clear coat 22, a photographic applique 24 and a melamine resin layer 26. Preferably, photographic applique 24 gives wooden substrate 12 the appearance of a hardwood floorboard when viewed through clear coat 22. Alternatively, however, photographic applique 24 may provide any suitable appearance.

As shown, wooden substrate 12 includes a tongue 28 and a groove 30 which facilitate tongue-and-groove connections with adjacent floorboards. Alternatively, however, wooden substrate 12 may be configured to connect with adjacent floorboards in any suitable way.

In the example shown, wooden substrate 12 is planar and includes a flat outer surface 32. However, in some embodiments, wooden substrate 12 may not be planar and outer surface 32 may not be flat. For example, it is explicitly contemplated that wooden substrate 12 may be crown molding or trim which curves about the perimeter of an archway, and outer surface 32 may be curved according to a design pattern.

In the example shown, wooden substrate 12 includes two cavities 14, 16. Alternatively, however, wooden substrate 12 may include just one cavity, for example, but not limited to, a longitudinal channel or recess, or more than two cavities. Each cavity may be sized and shaped for receiving one or more ornaments. In the example shown, cavity 14 is configured to receive ornament 18 and cavity 16 is configured to receive ornament 20. Cavities and ornaments may be configured with any desired shape. For example, cavity 14 has a square cross-section whereas cavity 16 has an irregular cross-section resembling the letter “M”.

In some embodiments, a cavity may be sized to frictionally engage with an ornament received therein. For example, cavity 14 may have cross-sectional dimensions that are fractionally smaller than those of corresponding ornament 18. Thus, when ornament 18 is received in cavity 14 it may frictionally engage with (and perhaps elastically or plastically deform) inside walls 34 of cavity 14. Thus ornament 18 may be secured within cavity 14 by a friction fit without the use of adhesives or other mechanical fastenings. In other embodiments, adhesives, such as, for example, but not limited to, Hotfix adhesive, a clear silicone or bonding glue, or other mechanical fastenings may be used to secure an ornament inside a cavity.

In the example shown, cavity 16 and ornament 20 are irregularly shaped. Therefore, it may be more difficult to configure cavity 16 to produce a friction fit with ornament 20 when ornament 20 is received inside cavity 16. Thus, according to some embodiments, ornament 20 may be secured inside cavity 16 using adhesives, such as, for example, but not limited to, Hotfix adhesive, a clear silicone or bonding glue, or other mechanical fasteners such as nails, staples, or screws for example.

In some embodiments, the coloration of the inside walls of a cavity may substantially differ from the outer surface of a wooden substrate. In the example shown, wooden substrate 12 is a laminate floorboard including clear coat 22, photographic applique 24 and melamine layer 26. Where a cavity extends from outer surface 32 through photographic applique 24, inside walls 34 of the cavity will not have the benefit of the photographic applique when viewed from the outside. Accordingly, it may be desirable to paint, stain or otherwise alter the appearance of the inside walls 34 of the cavity to match or compliment the outer surface 32 or the ornament 18. It may be especially desirable to do so where the inside walls of the cavity can be seen through ornament when received therein.

In another example, the wooden substrate may be a stained hardwood floorboard. If the stain does not penetrate as deeply as the cavity, then the interior walls of the cavity may not match the outer surface of the wooden substrate and thus it may be desirable to color, stain or otherwise alter the appearance of the inside walls of the cavity to match or compliment the outer surface of the wooden substrate and/or the ornament to be received in the cavity.

However, it is contemplated that in other embodiments the appearance of the inside walls of a cavity may be left unaltered, even though the appearance of the inside walls differs from the appearance of the outer surface and even though the inside walls can be seen through the ornament inserted therein.

In the example shown ornament 18 includes one gem 36 and ornament 20 includes a plurality of gems 37 above a second substrate 38. In other embodiments, an ornament may include any number of gems arranged in any configuration.

As used herein, the term “gem” refers to precious and semi-precious gemstones, such as crystals, diamonds, rubies, emeralds etc. as well as real and artificial stones that resemble or emulate precious and semi-precious gemstones such as cubic zirconia (a diamond simulant composed of zirconium oxide) and moissanite for example.

Some ornaments may include a substrate, such as second substrate 38 of ornament 20. The second substrate may be fitted within cavity 16 and, in some examples, may be bonded within cavity 16 using an adhesive, such as, for example, but not limited to, Hotfix adhesive, a clear silicone or bonding glue. Gems 37 may be bonded to second substrate 38 to keep gems 37 securely arranged during and after insertion into cavity 16. The gem stones may be bonded to the second substrate using an adhesive, such as, for example, but not limited to, Hotfix adhesive, a clear silicone or bonding glue. The second substrate 38 may be first placed within the cavity 16 and then the gems 37 placed on the second substrate 38. Alternatively, the gems 37 may be first secured to the second substrate 38, and then the second substrate 38 is placed within the cavity 16. The second substrate 38 may be composed of any suitable material, for example, but not limited to, second substrate 38 may comprise a fabric material such as felt, velvet or silk; a transparent material such as a clear plastic sheet; or an open mesh.

The second substrate 38 may be used in addition to or instead of coloring the inside walls of a cavity. For example, a black velvet substrate may conceal the appearance of the inside walls of a cavity and emphasize the glitter of the gems.

In the example shown, second substrate 38 of ornament 20 is sized to cover substantially the entire surface of inside walls 34 of cavity 16. However, in alternative embodiments, second substrate 38 may be sized to cover less than the entire surface of the inside walls of a cavity. Similarly, ornament 20 is shown including gems 37 which cover substantially the entire surface area of second substrate 38. In alternative embodiments, the gems of an ornament may cover less than or more than the surface area of the second substrate 38.

Preferably, ornaments 18, 20 do not extend beyond the outer surface 32 of the wooden substrate 12 when inserted into cavities 14, 16 (e.g., protrude above surface 32 when the wooden substrate 12 is used in a floor). This may advantageously lessen the occurrence of objects interfering with, catching on or dislodging the ornaments 18, 20 when they move across ornamented wooden substrate 12. For example, recessing ornaments 18, 20 including gems 36, 37 beneath the outer surface 32 may prevent gems 36, 37 from being dislodged by the sliding of furniture across ornamented wooden floorboard 10.

However, in other embodiments, the ornaments 18, 20 may extend beyond the outer surface 32. For example, in the case of an ornamented crown molding or trim for a doorway, there may be less concern of gems being interfered with and thus it may be more appropriate to have the ornament extend beyond the outer surface of the wooden substrate.

In some embodiments, where the ornament does not extend beyond the outer surface of the wooden substrate, a substantially transparent cover such as a polycarbonate sheet (for example, Lexan™) may overlay the ornament. In the example shown, a cover 40 is configured to overlay ornament 20 when received in cavity 16. Cover 40 may be secured within cavity 16 using an adhesive, such as, for example, but not limited to, Hotfix adhesive, a clear silicone or bonding glue. Preferably, cover 40 is configured to be flush with the outer surface 32 once received inside cavity 16. Where outer surface 32 is not flat and planar, cover 40 may be shaped to emulate or compliment the design of outer surface 32. Alternatively, outer surface 32 may be flat and planar despite the shape of outer surface 32.

Preferably, after cover 40 has been inserted into cavity 16, the cracks between cover 40 and outer surface 32 along the perimeter of cavity 16 are sealed with a sealant such as, for example, but not limited to, a silicon sealant. Alternatively, however, the cracks may be left unsealed.

FIG. 1b shows another example of an ornamented substrate 40, in accordance with some embodiments of the invention. In the example shown, ornamented substrate 40 includes a substrate 42 ornamented with ornament 44. Substrate 42 may be, for example, trim for a door way. As shown, ornament 44 comprising crystals 46 is received in cavity 48 formed within a portion of surface 50 of substrate 42.

In the example shown, cavity 48 comprises a longitudinal channel. In some embodiments, cavity 48 may extend to a longitudinal edge 52 (as shown in FIG. 1b). This may permit the cavity 48 and ornament 44 to intersect with a complimentary cavity and ornament of another ornamented substrate, thereby forming a contiguous pattern of ornaments.

FIG. 1c shows a partially exploded view of another example of an ornamented substrate 60, in accordance with some embodiments of the invention. In the example shown, ornamented substrate 60 comprises substrate 62, lighting 64 and ornament 66. Lighting 64 and ornament 66 are configured to be received in a cavity 68 of substrate 62. Lighting 64 may be configured to be received in cavity 68. In some embodiments, cavity 68 may comprise pockets 69 configured to receive lighting 64.

Lighting 64 may comprise lights 80 and one or more power cables 72. Lights 80 may be, for example, LED lights, halogen lights, or incandescent lights. A passage 70 may be provided in substrate 63 to provide a path for power cables 72 of lighting 64 to a power source (not shown) such as a power outlet or a battery, for example.

in the example shown, ornament 66 includes a second substrate 74 and gems 76. Optionally, second substrate 74 may include openings 78 which align with the lights 80 of the lighting 64. This may permit light from lighting 64 to shine through second substrate 74 even if second substrate 74 is opaque. Alternatively, second substrate 74 may not include openings 78. For example, second substrate 74 may be transparent or translucent and light from lighting 64 may shine through the material of second substrate 74.

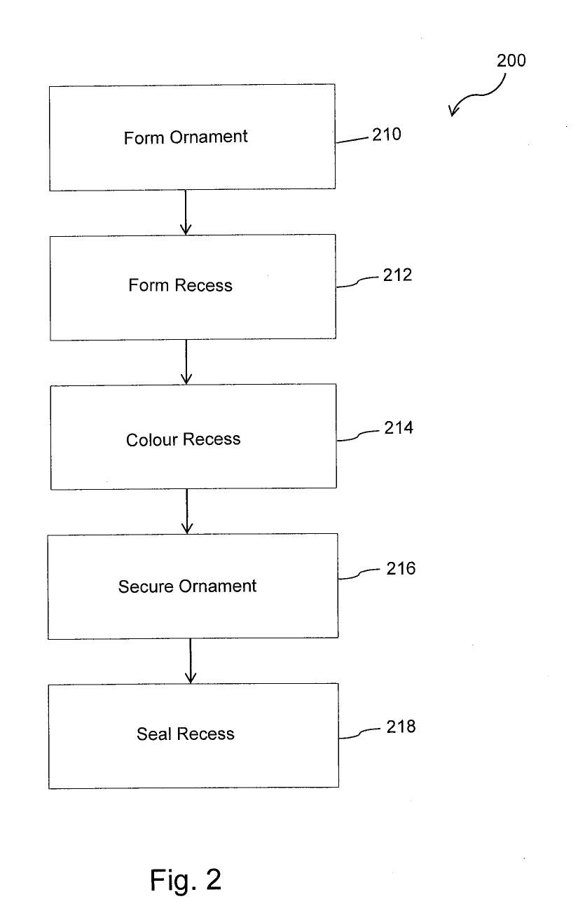

Referring now to FIG. 2, there is shown method for inlaying an ornament into a wooden substrate, in accordance with some embodiments of the invention.

At 210, an ornament is optionally formed. For example, where an ornament comprises a plurality of gems and a second substrate, this may comprise adhering or otherwise securing the gems to the second substrate. In some embodiments, it is not necessary to form an ornament. For example, it may not be necessary to form an ornament when the ornament comprises a single gem.

At 212, the cavity (for example, a recess) is formed. Forming the cavity may be performed before or after forming the ornament. Forming the cavity may comprise chiseling, machining, cutting, or otherwise removing material from the wooden substrate to create a cavity. Preferably, the cavity should not protrude right through the wooden substrate so as to create a through-hole. In some embodiments, however, a portion of the cavity may form a through-hole in the wooden substrate.

At 214, the cavity is optionally colored. For example, the cavity may be painted, stained, or lined with a colored material. In some embodiment, the cavity may not be colored. For example, after forming the cavity, the cavity may already have a suitable color, or the ornament to be received in the recess may include a suitably opaque substrate which can obscure the view of the inside walls of the cavity.

At 216, the ornament is secured in the cavity. In some embodiments, the ornament may be secured inside the cavity by a friction fit. In other embodiments, adhesives and/or mechanical fasteners may be used to secure the ornament inside the cavity. In embodiments where the ornament includes a second substrate, it may be sufficient to glue, staple, nail or screw the second substrate to the cavity either before or after gems are secured to the second substrate.

At 218, the cavity is optionally sealed. Sealing the cavity may comprise overlaying a cover sheet of substantially transparent material over the ornament inside the cavity. The cover may be configured to lay flush with the outer surface of the wooden substrate after insertion. A sealant such as a silicone sealant may be used to seal the cracks that remain between the cover and the outer surface of the wooden substrate along the perimeter of the cavity.

In some embodiments, the cavity may not be sealed. For example, the cavity may be left unsealed where there is little concern that the ornament inside the cavity will be interfered with. For example, an ornamented crown molding or trim around a doorway or along the upper edge of a wall may be left unsealed.

The invention has been described with regard to a number of embodiments. However, it will be understood by persons skilled in the art that other variants and modifications may be made without departing from the scope of the invention as defined in the claims appended hereto.

1-14. (canceled)

15. An ornamented substrate comprising:
a substrate including a cavity extending along a surface of the substrate; and
an ornament comprising one or more gems,
wherein the cavity is sized to receive the ornament and the ornament is secured in the cavity.

16. The ornamented substrate of claim 15 further comprising:
a substantially transparent cover in the cavity overlaying the ornament.

17. The ornamented substrate of claim 16 wherein the substantially transparent cover is flush with the surface of the substrate.

18. The ornamented substrate of claim 17 further comprising a sealant between the cover and the surface of the substrate.

19. The ornamented substrate of claim 15 wherein the ornament is friction fitted inside the cavity.

20. The ornamented substrate of claim 15 further comprising a second substrate between the one or more gems and the cavity of the substrate.

21. The ornamented substrate of claim 20 wherein the second substrate is selected from the group consisting of mesh and fabric.

22. The ornamented substrate of claim 15 further comprising lighting received in the cavity.
